(19) United States
(12) Patent Application Publication
(10) Pub. No.: US 2025/0295059 A1
(43) Pub. Date: Sep. 25, 2025

(54) ADAPTIVE MOWING ON GOLF COURSE MOWERS

(71) Applicant: Textron Inc., Providence, RI (US)

(72) Inventor: Brian David Wanta, North Augusta, SC (US)

(73) Assignee: Textron Inc., Providence, RI (US)

(21) Appl. No.: 18/614,169

(22) Filed: Mar. 22, 2024

(51) Int. Cl. A01D 34/00; A01D 34/66; A01D 34/74; A01D 34/78; A01D 34/835

(52) U.S. Cl. CPC A01D 34/008; A01D 34/66; A01D 34/74; A01D 34/78; A01D 34/835

(57) ABSTRACT

A mower includes a chassis, a tractive element coupled to the chassis, a cutting unit coupled to the chassis, the cutting unit including a housing and a cutting element rotatably coupled to the housing, a motor configured to move the cutting element relative to the housing, and a controller operatively coupled to the motor. The controller is configured to receive location data indicating at least one of a position or a travel speed of the mower and vary an operating condition of the cutting unit based on the location data.

### BACKGROUND

The present disclosure relates generally to outdoor equipment, such as mowers or golf cars. More specifically, the present disclosure relates to automated control of outdoor equipment.

Mowers are used to maintain vegetation (e.g., grass, clover, weeds, etc.) at a desired height. To accomplish this, mowers include at least one cutting unit having a cutting element that is driven by a motor and a driveline that facilitates navigation of the mower throughout an operating area. Mowers typically include operator controls that permit adjustment of a cutting speed of the cutting unit, a cutting height of the cutting unit, and/or a path followed by the mower (e.g., steering). These operator controls are manually adjusted by an operator, which is labor-intensive and introduces the potential for operator error.

### SUMMARY

One embodiment relates to a mower. The mower includes a chassis, a tractive element coupled to the chassis, a cutting unit coupled to the chassis, the cutting unit including a housing and a cutting element rotatably coupled to the housing, a motor configured to move the cutting element relative to the housing, and a controller operatively coupled to the motor. The controller is configured to receive location data indicating at least one of a position or a travel speed of the mower and vary an operating condition of the cutting unit based on the location data.

Another embodiment relates to a method of operating a mower. The method includes receiving, from a sensor, location data indicating at least one of a position or a travel speed of the mower, and determining, based on the location data, at least one of a desired cutting speed for a cutting unit of the mower or a desired cutting height for the cutting unit of the mower. The method further includes at least one of (a) controlling a motor of the mower to adjust a cutting speed of the cutting unit to the desired cutting speed or (b) controlling a deck actuator of the mower to adjust a cutting height of the cutting unit to the desired cutting height.

Still another embodiment relates to a vehicle system. The vehicle system includes one or more processing circuits including one or more memory devices storing instructions thereon that, when executed by one or more processors, cause the one or more processors to (a) receive, from at least one sensor, location data indicating a position and a travel speed of a mower, (b) control a motor of the mower to increase a cutting speed of a cutting unit of the mower in response to an increase in the travel speed of the motor, and (c) stop operation of the cutting unit in response to a determination that the mower has passed through a predefined geofence.

Still another embodiment relates to a mower. The mower includes a chassis, a driveline coupled to the chassis and configured to drive a tractive element to propel the mower, a cutting unit coupled to the chassis, the cutting unit including a housing and a cutting element rotatably coupled to the housing, and a controller operatively coupled to the driveline. The controller is configured to identify a desired path for the mower, receive location data indicating a current path being traveled by the mower, determine that the current path of the mower deviates from the desired path, and control the driveline to oppose the deviation of the current path from the desired path.

Still another embodiment relates to a method of operating a vehicle. The method includes receiving map data, the map data defining boundaries of a cart path on a golf course, receiving location data indicating a current path of the vehicle, and comparing the current path of the vehicle to the map data. The method further includes at least one of (a) controlling a haptic actuator to move a steering wheel of the vehicle to steer the vehicle toward the cart path in response to a determination that the vehicle is outside of the boundaries of the cart path or (b) controlling the haptic actuator to prevent the steering wheel from moving to a position that would cause the current path of the vehicle to extend outside of the boundaries of the cart path.

Still another embodiment relates to a vehicle system. The vehicle system includes one or more processing circuits including one or more memory devices storing instructions thereon that, when executed by one or more processors, cause the one or more processors to (a) receive map data defining a desired path for a mower and an area that the mower is not permitted to enter, the desired path being substantially straight, (b) receive location data indicating a current path being traveled by the mower, (c) compare the location data and the map data, (d) control a driveline of the mower to redirect the current path toward the desired path in response to a determination that the current path of the mower deviates from the desired path, and (e) control the driveline of the mower to prevent the mower from entering the area that the mower is not permitted to enter.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a perspective view of a vehicle, according to an exemplary embodiment.

FIG. 2 is a schematic block diagram of the vehicle of FIG. 1, according to an exemplary embodiment.

FIG. 3 is a is schematic block diagram of a site monitoring and control system including a plurality of the vehicles of FIG. 1, according to an exemplary embodiment.

FIG. 4 is a block diagram of a method for controlling the vehicle of FIG. 1, according to an exemplary embodiment.

FIGS. 5-9 are top views of maps of operating areas of the vehicle of FIG. 1, according to various exemplary embodiments.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

### Overall Vehicle

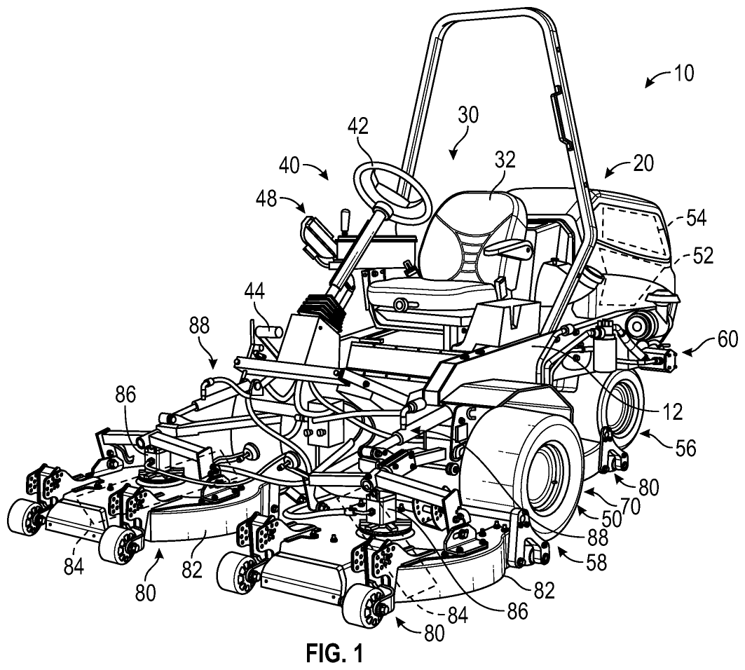

As shown in FIGS. 1-3, a machine or vehicle, shown as vehicle 10, includes a chassis, shown as frame 12; a body assembly, shown as body 20, coupled to the frame 12 and having an occupant portion or section, shown as occupant seating area 30; operator input and output devices, shown as operator controls 40, that are disposed within the occupant seating area 30; a drivetrain, shown as driveline 50, coupled to the frame 12 and at least partially disposed under the body 20; a vehicle suspension system, shown as suspension system 60, coupled to the frame 12 and one or more components of the driveline 50; a vehicle braking system, shown as braking system 70, coupled to one or more components of the driveline 50 to facilitate selectively braking the one or more components of the driveline 50; a series of implements, mower assemblies, or cutting units, shown as mower decks 80; one or more sensors, shown as sensors 90; and a vehicle control system, shown as vehicle controller 100, coupled to the operator controls 40, the driveline 50, the suspension system 60, the braking system 70, the mower decks 80, and the sensors 90. In other embodiments, the vehicle 10 includes more or fewer components.

According to an exemplary embodiment, the vehicle 10 is an off-road machine or vehicle. As shown in FIG. 1, the vehicle 10 is configured as a mower (e.g., a lawnmower, a turf mower, a push mower, a ride-on mower, a stand-on mower, or another type of mower). In other embodiments, the off-road machine or vehicle is a lightweight or recreational machine or vehicle such as a golf cart, golf cars, an all-terrain vehicle (“ATV”), a utility task vehicle (“UTV”), and/or another type of lightweight or recreational machine or vehicle. In some embodiments, the off-road machine or vehicle is a chore product such as aerator, turf sprayer, bunker rake, and/or another type of chore product (e.g., that may be used on a golf course).

According to the exemplary embodiment shown in FIG. 1, the occupant seating area 30 includes a single seat, shown as driver seat 32. In some embodiments, the occupant seating area 30 includes additional seats (e.g., a passenger seat, an additional row of seats, etc.). According to the exemplary embodiment shown in FIG. 1, the driver seat 32 is laterally centered on the body 20 and facing forward. In some embodiments, the driver seat 32 is facing rearward or otherwise positioned. In some embodiments, the occupant seating area 30 is omitted (e.g., the vehicle 10 is configured as a push mower). A portion of the frame 12 defines a platform, deck, or standing area, shown as operator platform 34. The operator platform 34 may extend forward of the driver seat 32 such that the occupant can rest their feet on the operator platform 34 while seated in the driver seat 32. The operator platform 34 may support the occupant as the occupant enters or exits the driver seat 32.

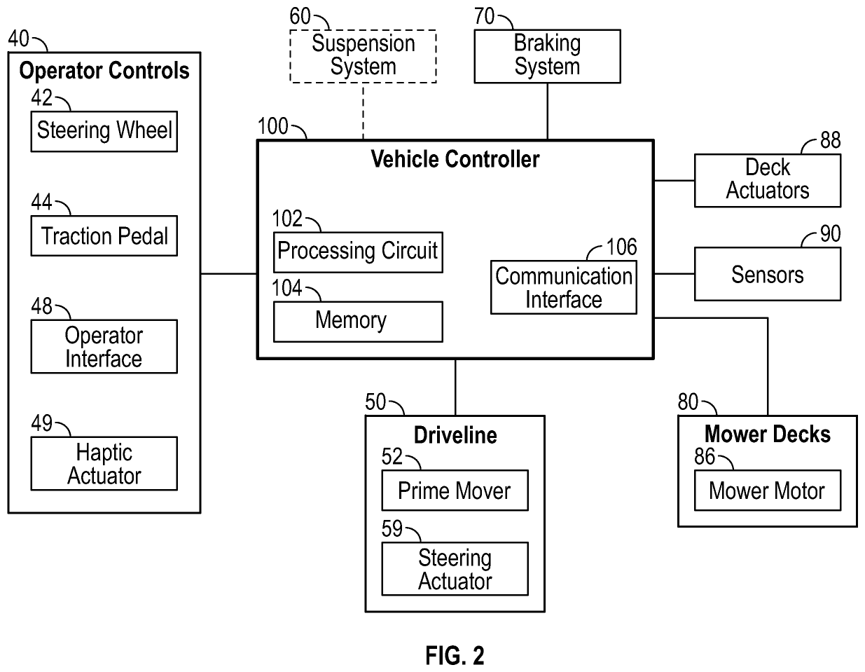

According to an exemplary embodiment, the operator controls 40 are configured to provide an operator with the ability to control one or more functions of and/or provide commands to the vehicle 10 and the components thereof (e.g., turn on, turn off, drive, turn, brake, engage various operating modes, raise/lower a mower deck 80, etc.). As shown in FIGS. 1 and 2, the operator controls 40 include a steering interface (e.g., a steering wheel, joystick(s), etc.), shown steering wheel 42, an accelerator interface and/or braking interface (e.g., a pedal, a throttle, etc.), shown as traction pedal 44, and one or more additional interfaces, shown as operator interface 48. The steering wheel 42 may be used by an operator to indicate a desired steering direction of the vehicle 10. The traction pedal 44 may be used to control the speed and direction of travel of the vehicle 10. By way of example, pressing the traction pedal 44 in a first direction may cause the driveline 50 to move the vehicle 10 forward, and pressing the traction pedal 44 in an opposing section direction may cause the driveline 50 to move the vehicle 10 rearward. Returning the traction pedal 44 to a middle or neutral position may cause the braking system 70 and/or the driveline 50 to slow or stop the vehicle 10 or to hold the vehicle 10 in place. Alternatively, the operator interface 48 may include a pair of handles that act as a steering interface and control the driveline 50 in a zero-turn configuration (e.g., a left joystick to control the left side of the driveline 50 and a right joystick to control a right side of the driveline 50). The operator interface 48 may be used to control operation of the mower decks 80 (e.g., changing a cutting speed of a mower deck 80, changing a cutting height of a mower deck 80, etc.). The operator interface 48 may include one or more displays and one or more input devices. The one or more displays may be or include a touchscreen, an LCD display, a LED display, a speedometer, gauges, warning lights, etc. The one or more input device may be or include buttons, switches, knobs, levers, dials, etc.

In some embodiments, the operator controls 40 include one or more haptic feedback devices (e.g., motors, vibrators, etc.), shown as haptic actuator 49. The haptic actuator 49 provides haptic feedback (e.g., vibration, force, resistance to movement of a component of the vehicle 10, etc.). By way of example, the haptic actuator 49 may vibrate a component contacted by the operator (e.g., the driver seat 32, the steering wheel 42, etc.) to indicate information an operator. By way of another example, the haptic actuator 49 apply a force to a component of the operator controls 40 to communicate information to the operator and/or directly control operation of the vehicle 10. In one such example, the haptic actuator 49 resists rotation of the steering wheel 42 to encourage the operator to steer in a given direction. In another such example, the haptic actuator 49 move the steering wheel 72 to a desired position corresponding to a desired steering heading or steering direction.

According to an exemplary embodiment, the driveline 50 is configured to propel the vehicle 10. As shown in FIGS. 1 and 2, the driveline 50 includes a primary driver, shown as prime mover 52, an energy storage device, shown as energy storage 54, a first tractive assembly (e.g., axles, wheels, tracks, differentials, etc.), shown as rear tractive assembly 56, and a second tractive assembly (e.g., axles, wheels, tracks, differentials, etc.), shown as front tractive assembly 58. In some embodiments, the driveline 50 is a conventional driveline whereby the prime mover 52 is an internal combustion engine and the energy storage 54 is a fuel tank. The internal combustion engine may be a spark-ignition internal combustion engine or a compression-ignition internal combustion engine that may use any suitable fuel type (e.g., diesel, ethanol, gasoline, natural gas, propane, etc.). In some embodiments, the driveline 50 is an electric driveline whereby the prime mover 52 is one or more electric motors and the energy storage 54 is a battery system. In some embodiments, the driveline 50 is a fuel cell electric driveline whereby the prime mover 52 is one or more electric motors and the energy storage 54 is a fuel cell (e.g., that stores hydrogen, that produces electricity from the hydrogen, etc.). In some embodiments, the driveline 50 is a hybrid driveline whereby (i) the prime mover 52 includes an internal combustion engine and an electric motor/generator and (ii) the energy storage 54 includes a fuel tank and/or a battery system. According to the exemplary embodiment shown in FIG. 1, the rear tractive assembly 56 includes rear tractive elements and the front tractive assembly 58 includes front tractive elements that are configured as wheels. In some embodiments, the rear tractive elements and/or the front tractive elements are configured as tracks. In some embodiments, the driveline 50 is omitted, and the vehicle 10 is propelled by an operator (e.g., the vehicle 10 is configured as a push mower).

According to an exemplary embodiment, the prime mover 52 is configured to provide power to drive the rear tractive assembly 56 and/or the front tractive assembly 58 (e.g., to provide front-wheel drive, rear-wheel drive, four-wheel drive, and/or all-wheel drive operations). In some embodiments, the driveline 50 includes a transmission device (e.g., a gearbox, a continuous variable transmission (“CVT”), etc.) positioned between (a) the prime mover 52 and (b) the rear tractive assembly 56 and/or the front tractive assembly 58. The rear tractive assembly 56 and/or the front tractive assembly 58 may include a drive shaft, a differential, and/or an axle. In some embodiments, the rear tractive assembly 56 and/or the front tractive assembly 58 include two axles or a tandem axle arrangement. In some embodiments, the rear tractive assembly 56 and/or the front tractive assembly 58 are steerable (e.g., based on an input from the steering wheel 42 and using a steering actuator 59 that controls the orientation of one or more wheels). In some embodiments, both the rear tractive assembly 56 and the front tractive assembly 58 are fixed and not steerable (e.g., employ skid steer operations). By way of example, the driveline 50 may include a hydrostatic transmission that permits independent driving of the left and right sides of the driveline 50.

In some embodiments, the driveline 50 includes a plurality of prime movers 52. By way of example, the driveline 50 may include a first prime mover 52 that drives the rear tractive assembly 56 and a second prime mover 52 that drives the front tractive assembly 58. By way of another example, the driveline 50 may include a first prime mover 52 that drives a first one of the front tractive elements, a second prime mover 52 that drives a second one of the front tractive elements, a third prime mover 52 that drives a first one of the rear tractive elements, and/or a fourth prime mover 52 that drives a second one of the rear tractive elements. By way of still another example, the driveline 50 may include a first prime mover 52 that drives the front tractive assembly 58, a second prime mover 52 that drives a first one of the rear tractive elements, and a third prime mover 52 that drives a second one of the rear tractive elements. By way of yet another example, the driveline 50 may include a first prime mover 52 that drives the rear tractive assembly 56, a second prime mover 52 that drives a first one of the front tractive elements, and a third prime mover 52 that drives a second one of the front tractive elements.

According to an exemplary embodiment, the suspension system 60 includes one or more suspension components (e.g., shocks, dampers, springs, etc.) positioned between the frame 12 and one or more components (e.g., tractive elements, axles, etc.) of the rear tractive assembly 56 and/or the front tractive assembly 58. In some embodiments, the vehicle 10 does not include the suspension system 60.

According to an exemplary embodiment, the braking system 70 includes one or more braking components (e.g., disc brakes, drum brakes, in-board brakes, axle brakes, etc.) positioned to facilitate selectively braking one or more components of the driveline 50. In some embodiments, the one or more braking components include (i) one or more front braking components positioned to facilitate braking one or more components of the front tractive assembly 58 (e.g., the front axle, the front tractive elements, etc.) and (ii) one or more rear braking components positioned to facilitate braking one or more components of the rear tractive assembly 56 (e.g., the rear axle, the rear tractive elements, etc.). In some embodiments, the one or more braking components include only the one or more front braking components. In some embodiments, the one or more braking components include only the one or more rear braking components. In some embodiments, the one or more front braking components include two front braking components, one positioned to facilitate braking each of the front tractive elements. In some embodiments, the one or more rear braking components include two rear braking components, one positioned to facilitate braking each of the rear tractive elements. In some embodiments, the driveline 50 is a hydrostatic transmission that performs braking by using hydraulic motors to oppose movement of the tractive elements.

Referring to FIG. 1, the vehicle 10 includes a series of mower decks 80 (e.g., cutting units). Each mower deck 80 includes a deck, housing, or enclosure, shown as housing 82, and a cutting element 84 (e.g., a blade, a flail, a reel, etc.) movably coupled to the housing 82. The housing 82 may open downward to expose the cutting element 84 to vegetation below the housing 82. A motor or actuator (e.g., an electric motor, a hydraulic motor, etc.), shown as mower motor 86, is coupled to the housing 82 and drives movement (e.g., rotation, oscillation, etc.) of the cutting element 84. While driven by the mower motor 86, the cutting element 84 crushes, mulches, removes, or otherwise trims vegetation beneath the housing 82. Alternatively, the cutting element 84 may be driven by the prime mover 52 (e.g., through a power take off).

The vehicle 10 includes a series of linear actuators or height adjustment actuators, shown as deck actuators 88, each coupled to the frame 12 and to one or more of the mower decks 80. The deck actuators 88 permit control over a height of the corresponding mower deck 80 relative to the frame 12. The deck actuators 88 may set a cutting height of the mower deck 80. The cutting height represents a final height of vegetation that is trimmed by the mower deck 80. The deck actuators 88 may move the mower deck 80 to a travel position above the cutting height, in which the mower deck 80 is moved out of engagement with the vegetation and the ground surface. The travel position may be used when the vehicle 10 is traveling between job sites and/or the user does not wish to be trimming vegetation.

The sensors 90 may include various sensors positioned about the vehicle 10 to acquire vehicle information or vehicle data regarding operation of the vehicle 10, or the location thereof. The sensors 90 may include various sensors positioned about the vehicle 10 to acquire environment data regarding the environment surrounding the vehicle 10. By way of example, the sensors 90 may include an accelerometer, a gyroscope, a compass, a position sensor (e.g., a GPS sensor, an RTK sensor, etc.), an inertial measurement unit (“IMU”), suspension sensor(s), wheel sensors, an audio sensor or microphone, a camera, an optical sensor, a proximity detection sensor, linear potentiometers, and/or other sensors to facilitate acquiring vehicle information, vehicle data, or environment data regarding operation of the vehicle 10, the location thereof, and/or the surrounding environment. According to an exemplary embodiment, one or more of the sensors 90 are configured to facilitate detecting and obtaining vehicle telemetry data including position of the vehicle 10, whether the vehicle 10 is moving, travel direction of the vehicle 10, slope of the vehicle 10, speed of the vehicle 10, vibrations experienced by the vehicle 10, sounds proximate the vehicle 10, suspension travel of components of the suspension system 60, and/or other vehicle telemetry data.

As shown in FIG. 2, the vehicle controller 100 may be implemented as a general-purpose processor, an application specific integrated circuit (“ASIC”), one or more field programmable gate arrays (“FPGAs”), a digital-signal-processor (“DSP”), circuits containing one or more processing components, circuitry for supporting a microprocessor, a group of processing components, or other suitable electronic processing components. According to the exemplary embodiment shown in FIG. 2, the vehicle controller 100 includes a processing circuit 102, a memory 104, and a communication interface 106. The processing circuit 102 may include an ASIC, one or more FPGAs, a DSP, circuits containing one or more processing components, circuitry for supporting a microprocessor, a group of processing components, or other suitable electronic processing components. In some embodiments, the processing circuit 102 is configured to execute computer code stored in the memory 104 to facilitate the activities described herein. The memory 104 may be any volatile or non-volatile or non-transitory computer-readable storage medium capable of storing data or computer code relating to the activities described herein. According to an exemplary embodiment, the memory 104 includes computer code modules (e.g., executable code, object code, source code, script code, machine code, etc.) configured for execution by the processing circuit 102. In some embodiments, the vehicle controller 100 may represent a collection of processing devices. In such cases, the processing circuit 102 represents the collective processors of the devices, and the memory 104 represents the collective storage devices of the devices.

In one embodiment, the vehicle controller 100 is configured to selectively engage, selectively disengage, control, or otherwise communicate with components of the vehicle 10 (e.g., via the communication interface 106, a controller area network (“CAN”) bus, etc.). According to an exemplary embodiment, the vehicle controller 100 is coupled to (e.g., communicably coupled to) components of the operator controls 40 (e.g., the steering wheel 42, the traction pedal 44, the brake 46, the operator interface 48, etc.), components of the driveline 50 (e.g., the prime mover 52), components of the braking system 70, the mower decks 80, the deck actuators 88, and the sensors 90. By way of example, the vehicle controller 100 may send and receive signals (e.g., control signals, location signals, etc.) with the components of the operator controls 40, the components of the driveline 50, the components of the braking system 70, the sensors 90, and/or remote systems or devices (via the communication interface 106 as described in greater detail herein).

The communication interface 106 facilitate communications (e.g., wired or wireless communications) between the vehicle 10 and other devices (e.g., other vehicles 10, the user sensors 220, the user portal 230, the remote systems 240, etc.). By way of example, the communications interface 130 may be configured to employ one or more types of wireless communications protocols including Bluetooth, Wi-Fi, radio, cellular, and/or other suitable wireless communications protocols.

### Site Monitoring and Control System

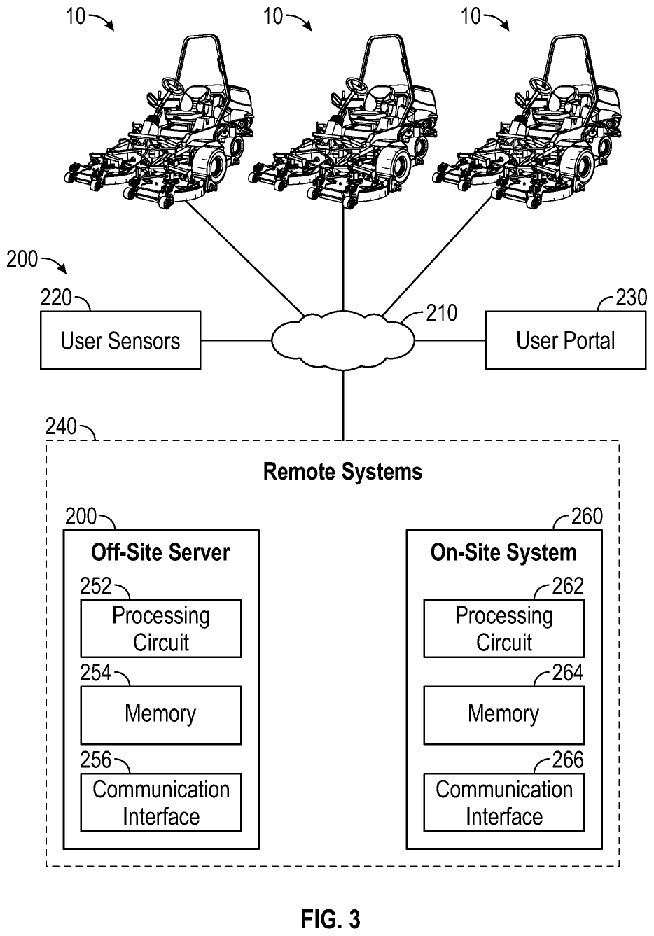

As shown in FIG. 3, a monitoring and control system, shown as site monitoring and control system 200, includes one or more vehicles 10; one or more second sensors, shown as user sensors 220, positioned remote or separate from the vehicles 10; an operator interface, shown as user portal 230, positioned remote or separate from the vehicles 10; and one or more external processing systems, shown as remote systems 240, positioned remote or separate from the vehicles 10. The vehicles 10, the user sensors 220, the user portal 230, and the remote systems 240 communicate via one or more communications protocols (e.g., Bluetooth, Wi-Fi, cellular, radio, through the Internet, etc.) through a network, shown as communications network 210 (e.g., using the communication interface 106).

The user sensors 220 may be or include one or more sensors that are carried by or worn by an operator of one of the vehicles 10. By way of example, the user sensors 220 may be or include a wearable sensor (e.g., a smartwatch, a fitness tracker, a pedometer, hear rate monitor, etc.) and/or a sensor that is otherwise carried by the operator (e.g., a smartphone, etc.) that facilitates acquiring and monitoring operator data (e.g., physiological conditions such a temperature, heartrate, breathing patterns, etc.; location; movement; etc.) regarding the operator. The user sensors 220 may communicate directly with the vehicles 10, directly with the remote systems 240, and/or indirectly with the remote systems 240 (e.g., through the vehicles 10 as an intermediary).

The user portal 230 may be configured to facilitate operator access to dashboards including the vehicle data, the operator data, information available at the remote systems 240, etc. to manage and operate the site (e.g., golf course) such as for advanced scheduling purposes, to identify persons braking course guidelines or rules, to monitor locations of the vehicles 10, etc. The user portal 230 may also be configured to facilitate operator implementation of configurations and/or parameters for the vehicles 10 and/or the site (e.g., setting speed limits, setting geofences, etc.). The user portal 230 may be or may be accessed via a computer, laptop, smartphone, tablet, or the like.

As shown in FIG. 3, the remote systems 240 include a first remote system, shown as off-site server 250, and a second remote system, shown as on-site system 260 (e.g., in a clubhouse of a golf course, on the golf course, etc.). In some embodiments, the remote systems 240 include only one of the off-site server 250 or the on-site system 260. As shown in FIG. 3, (a) the off-site server 250 includes a processing circuit 252, a memory 254, and a communications interface 256 and (b) the on-site system 260 includes a processing circuit 262, a memory 264, and a communications interface 266.

According to an exemplary embodiment, the remote systems 240 (e.g., the off-site server 250 and/or the on-site system 260) are configured to communicate with the vehicles 10 and/or the user sensors 220 via the communications network 210. By way of example, the remote systems 240 may receive the vehicle data from the vehicles 10 and/or the operator data from the user sensors 220. The remote systems 240 may be configured to perform back-end processing of the vehicle data and/or the operator data. The remote systems 240 may be configured to monitor various global positioning system (“GPS”) information and/or real-time kinematics (“RTK”) information (e.g., position/location, speed, direction of travel, geofence related information, etc.) regarding the vehicles 10 and/or the user sensors 220. The remote systems 240 may be configured to transmit information, data, commands, and/or instructions to the vehicles 10. By way of example, the remote systems 240 may be configured to transmit GPS data and/or RTK data based on the GPS information and/or RTK information to the vehicles 10 (e.g., which the vehicle controllers 100 may use to make control decisions). By way of another example, the remote systems 240 may send commands or instructions to the vehicles 10 to implement.

According to an exemplary embodiment, the remote systems 240 (e.g., the off-site server 250 and/or the on-site system 260) are configured to communicate with the user portal 230 via the communications network 210. By way of example, the user portal 230 may facilitate (a) accessing the remote systems 240 to access data regarding the vehicles 10 and/or the operators thereof and/or (b) configuring or setting operating parameters for the vehicles 10 (e.g., geofences, speed limits, times of use, permitted operators, etc.). Such operating parameters may be propagated to the vehicles 10 by the remote systems 240 (e.g., as updates to settings) and/or used for real time control of the vehicles 10 by the remote systems 240.

### Automatic Vehicle Control Method

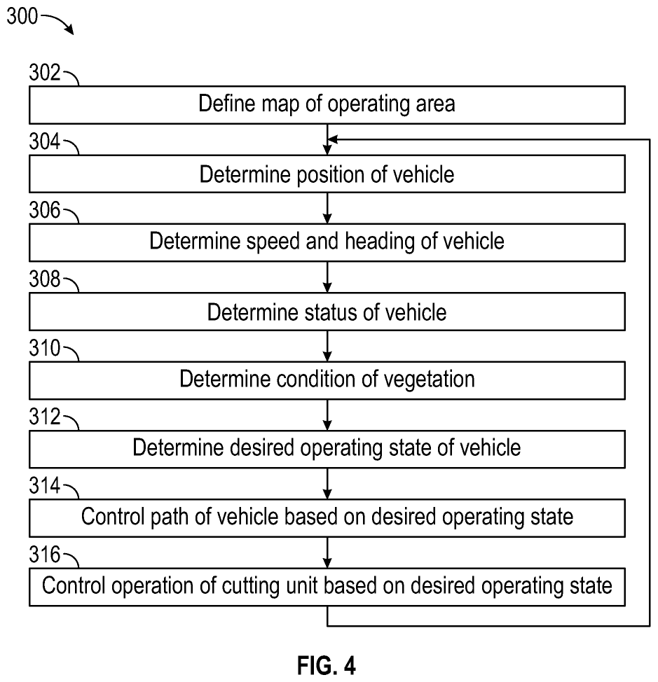

Referring to FIG. 4, a method for automatically controlling operation of a vehicle 10 is shown as a method 300, according to an exemplary embodiment. The method 300 may control the vehicle 10 to operate autonomously or semi-autonomously to accomplish a desired task. In some embodiments, the method 300 facilitates vegetation management (e.g., mowing) throughout an area. By way of example, the method 300 may be utilized to control the vehicle 10 to mow a golf course according to a desired map. A golf course may have various areas or zones, each associated with a desired vegetation condition, and each vegetation condition may have a corresponding operation of the vehicle 10. The method 300 may facilitate identifying the zone currently occupied by the vehicle 10 and controlling the vehicle 10 accordingly. The method 300 may require human intervention (e.g., by signaling to the operator how the vehicle 10 should be operated) or may be executed to autonomously operate the vehicle 10.

The method 300 includes various processes. For ease of description, the processes of the method 300 are described as being performed by the vehicle controller 100. It should be understood, however, that the processes may be performed by any component of the control system 200. By way of example, the processes of the method 300 may be performed by the vehicle controllers 100 and/or the remote system 240. In some embodiments, one or more processes are performed wholly by one component of the control system 200 (e.g., a vehicle controller 100 performs the entire process). In some embodiments, one or more processes are distributed across multiple components (e.g., a portion of the processing is performed by a vehicle controller 100, and another portion of the processing is performed by an off-site server 250).

### Mapping Operating Area

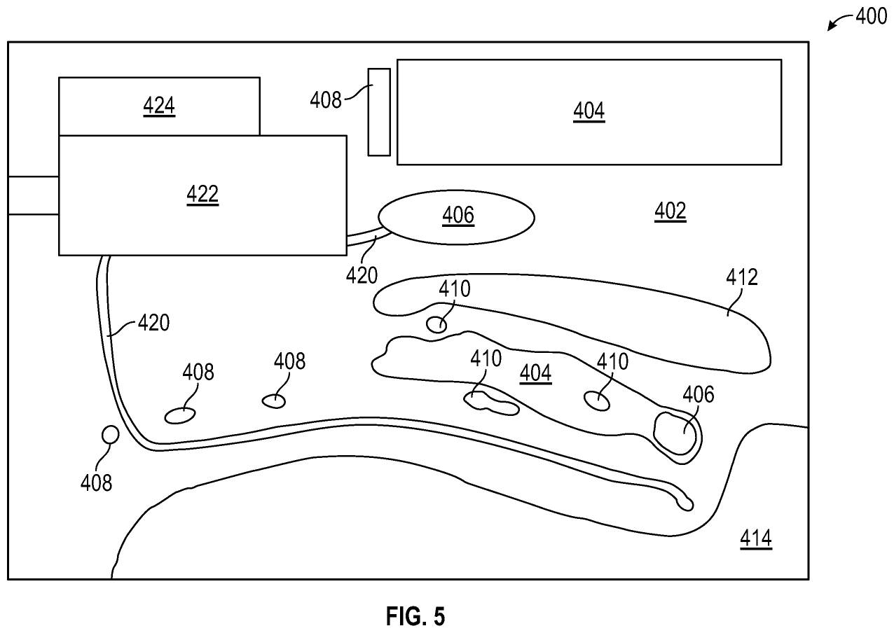

In step 302 of the method 300, a map of an operating area is defined. The operating area may be any area or location range in which the vehicle 10 is intended to operate. FIG. 5 illustrates a graphical representation of map data, shown as a map 400, that illustrates an operating area. As shown, the operating area illustrated by the map 400 is a golf course. In other embodiments, the map 400 characterizes another type of operating area (e.g., a soccer field, a baseball diamond, a dog park, a garden, etc.). While the map 400 is shown graphically for ease of illustration, the map data associated be defined and stored without a graphical illustration (e.g., as a table or other group of data points).

As shown in FIG. 5, the map 400 includes a series of zones, areas, sections, sectors, or regions that each represent a portion of the operating area. Each zone may have an associated shape, size, and location such that the boundaries of the zones are predetermined and stored in the map data (e.g., as a predefined geofence). Based on the map data, the vehicle controller 100 may determine which zone contains a specific coordinate. By way of example, a sensor 90 may supply a coordinate representing a current position of the vehicle 10, and the vehicle controller 100 may use the map data and coordinate to determine in which zone the vehicle 10 is currently present.

Each zone may be associated with one or more properties, and these corresponding physical properties may be stored in the map data. These properties may represent desired physical properties that a manager of the system wishes to maintain within the zone. By way of example, the map data may include surface type data indicating a material that is desired on the ground within the zone (e.g., vegetation, sand, pavement, etc.). By way of example, the map data may include vegetation type data indicating a type or species of vegetation that is desired for the zone (e.g., grasses, such as Bermuda Grass, Kentucky Bluegrass, Zoysia, Fescue, Poa Annua, etc.). By way of example, the map data may include vegetation height data indicating a desired height of vegetation within the zone. By way of example, the map data may include mowing pattern data indicating a desired mowing or orientation for vegetation within the area. By way of example, the map data may include permission data indicating whether or not a vehicle 10 has permission to access a zone. By way of example, the map data may include topographic data indicating an elevation profile of the zone (e.g., the elevation at multiple points within the zone, the contour of the ground surface throughout the zone, etc.).

FIG. 5 illustrates an example of a map 400 of an operating area, shown as a golf course. The map 400 includes a first zone, shown as rough 402, containing grass that is relatively tall. The map 400 includes a second zone, shown as fairway 404, containing grass that is shorter than the grass of the rough 402. The map 400 includes a series of third zones, shown as greens 406, containing grass that is shorter than the grass of the fairway 404. The greens 406 may each contain a hole intended to receive a golf ball. The map 400 includes a series of fourth zones, shown as tee boxes 408, containing grass that is shorter than the grass of the rough 402. The tee boxes 408 may represent areas where a golf ball is initially staged when playing a hole, and may be offset at different distances from the hole (e.g., corresponding to different handicaps).

The map 400 includes a series of fifth zones or obstacles, shown as bunkers 410 or sand traps, containing a granular material, such as sand. The map data may indicate that the bunkers 410 should not be mowed (e.g., the vehicle 10 is not permitted to enter the bunkers 410). The map 400 includes a series of sixth zones, obstacles, or stands of trees, shown as tree zones 412, containing one or more trees. The tree zones 412 may also include grass or other vegetation that is maintained as part of the golf course. The map 400 includes a seventh zone or obstacle, shown as fescue 414, containing grass that is longer than the grass of the rough 402. The map data may include vegetation height data, mowing pattern data, and vegetation type data for the grasses within the rough 402, the fairway 404, the greens 406, the tee boxes 408, the tree zones 412, and/or the fescue 414.

The map 400 includes a series of eighth zones or cart areas, shown as cart paths 420, extending throughout various areas of the map 400. The cart paths 420 may be coated with a durable road material (e.g., pavement, asphalt, concrete, gravel, etc.) different from the grass of the surrounding zones, or otherwise configured to facilitate repeated travel by the vehicle 10 or other vehicles (e.g., golf carts, UTVs, etc.). The map data may include permission data indicating that certain vehicles may travel along the cart paths 420 (e.g., preventing the vehicles from moving off of the cart paths 420, preventing the vehicles from moving into the adjacent rough 402, etc.). The map 400 includes a ninth zone, shown as parking lot 422, having a section of road material intended to support multiple vehicles. The parking lot 422 may be contiguous with the cart path 420. The map 400 includes a tenth zone, shown as building 424 (e.g., a clubhouse, a pro shop, a restaurant, a garage, etc.). The map data may include permission data that limits or prevents the vehicle 10 from traveling into the building 424.

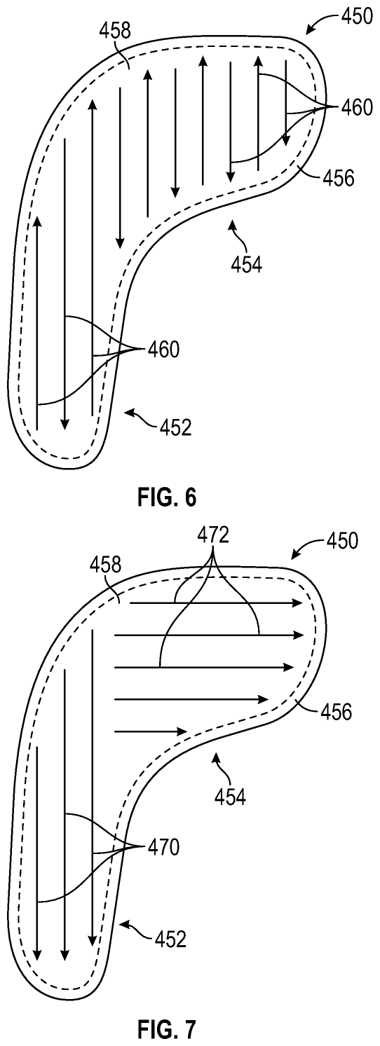

FIGS. 6-8 illustrate a map section 450, which represents a portion of a map (e.g., the map 400). By way of example, the map section 450 may represent a fairway 404. The map section 450 includes a first section (e.g., extending generally north-south), shown as first portion 452, and a second section (e.g., extending generally east-west), shown as second portion 454. The first portion 452 and the second portion 454 accordingly extend substantially perpendicular to one another, forming an L-shape or dogleg.

The map section 450 further includes an outer section, shown as border region 456, and an inner section or central section, shown as pattern region 458. The border region 456 extends along the outer perimeter of the fairway 404. In some embodiments, the mower path (i.e., the path followed by the vehicle 10 when mowing) within the border region 456 follows the contour of the outer perimeter of the fairway 404. In some embodiments, the mower path within the pattern region 458 follows a different mowing pattern than that of the border region 456 (e.g., a pattern independent of the contour of the outer perimeter of the fairway 404. The inclusion of the border region 456 may be desirable to accurately define the outer perimeter of the fairway 404.

FIGS. 6-9 each illustrate a different example of the pattern region 458, according to various embodiments. The mowing pattern may be selected by a user (e.g., according to personal preference, speed of operation, or a resulting visual effect on the cut grass). In FIG. 6, the mowing pattern includes a series of mower paths 460 covering the pattern region 458. The mower paths 460 are all substantially straight. Each of the mower paths 460 extend substantially parallel to one another (e.g., generally north-south and along the first portion 452) throughout both the first portion 452 and the second portion 454. The mower paths 460 alternate directions (e.g., north, then south, then north, etc.). The mower paths 460 are spaced from one another such that the areas mowed by each adjacent mower path 460 overlap one another and cover the entire pattern region 458.

In FIG. 7, the mowing pattern includes a series of mower paths 470 and a series of mower paths 472 covering the pattern region 458. The mower paths 470 and 472 are all substantially straight. Each of the mower paths 470 extend substantially parallel to one another (e.g., generally north-south and along the first portion 452) throughout the first portion 452. The mower paths 470 all extend in the same direction (e.g., all south, etc.). The mower paths 470 are spaced from one another such that the areas mowed by each adjacent mower path 470 overlap one another and cover the first portion 452. Each of the mower paths 472 extend substantially parallel to one another (e.g., generally east-west and along the second portion 454) throughout the second portion 454. The mower paths 472 all extend in the same direction (e.g., all east, etc.). The mower paths 472 are spaced from one another such that the areas mowed by each adjacent mower path 472 overlap one another and cover the first portion 452.

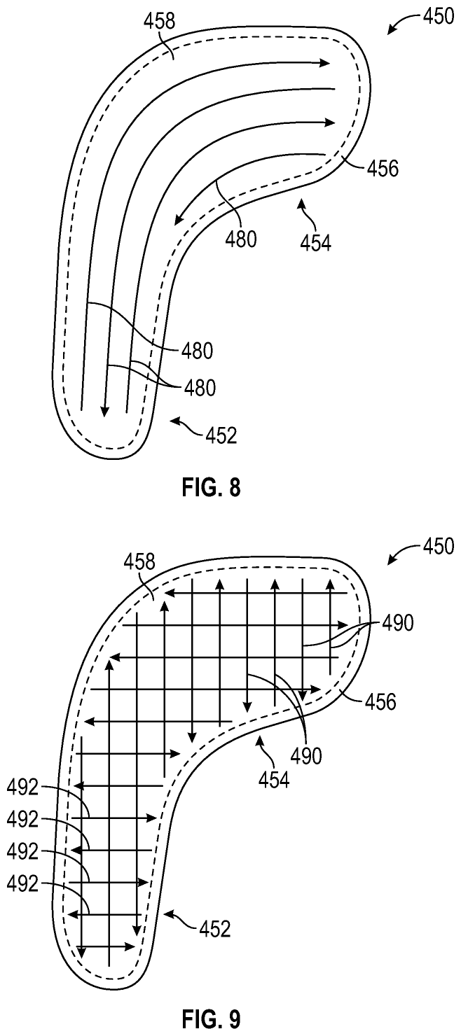

In FIG. 8, the mowing pattern includes a series of mower paths 480 covering the pattern region 458. The mower paths 480 are curved to extend along both the first portion 452 and the second portion 454 (e.g., generally straight north-south within the first portion 452 and generally straight east-west within the second portion 454 with a curved transition portion in between). The mower paths 480 alternate directions. The mower paths 480 are spaced from one another such that the areas mowed by each adjacent mower path 480 overlap one another by a fixed distance.

In FIG. 9, the mowing pattern includes a series of mower paths 490 and a series of mower paths 492 covering the pattern region 458. The mower paths 490 and 492 are all substantially straight. Each of the mower paths 490 extend substantially parallel to one another (e.g., generally north-south) throughout both the first portion 452 and the second portion 454. Each of the mower paths 492 extend substantially parallel to one another (e.g., generally east-west) throughout both the first portion 452 and the second portion 454. The mower paths 490 intersect (e.g., extend nonparallel or substantially perpendicular to) the mower paths 492, forming a checkered pattern in the cut grass. The mower paths 490 and 492 each alternate directions.

In some embodiments, the map 400 is manually generated by a user. By way of example, the user portal 230 may provide a user with a graphical user interface (GUI) showing the operating area. The user portal 230 may utilize existing map data of the operating area (e.g., provided by a third party map service). The existing map data may provide include a graphical representation of the operating area, and may include corresponding topographical data. Through the GUI of the user portal 230, the user may define the boundaries one or more zones on the graphical representation of the operating area. By way of example, the user may draw the boundaries using a mouse or touchscreen display. The user may then manually define one or more properties of each zone (e.g., surface type data, vegetation type data, vegetation height data, mowing pattern data, permission data, topographic data, etc.).

In some embodiments, the map 400 is generated based on data collected during operation of a vehicle 10 (e.g., a sample mowing operation is performed to train the map 400). By way of example, a user may manually operate the vehicle 10 to perform a mowing operation within the operating area. This mowing operation may represent a model mowing operation that a user desires to replicate or imitate in the future. While the mowing operation is performed, the vehicle controller 100 may record the data provided by the sensors 90 and the commands sent to components of the vehicle 10. This recorded data may be correlated and used to generate the map data.

In one example, the user trains a portion of the map 400 including a fairway 404. Prior to beginning the mowing operation, the user sets the cutting height of the mower deck 80 to correspond to the desired length of the grass within the fairway 404. The user navigates the vehicle 10 to the fairway 404. The user may manually initiate a training period, or the vehicle controller 100 may initiate the training period automatically. The user then manually operates the vehicle 10 to cut the grass as desired and concludes the training period. Throughout the training period, the vehicle controller 100 may monitor and record data from the sensors 90 and commands sent to the components of the vehicle 10.

The location of the vehicle 10 may be provided by a sensor 90 and correlated to the rest of the recorded data to generate the map 400. By way of example, the vehicle controller 100 may monitor the speed and heading of the vehicle 10 at each location to generate the mowing pattern data. By way of another example, the vehicle controller 100 may monitor the type of surface below the vehicle 10 (e.g., based on image data from a camera) at each location to determine the surface type data and vegetation type data). By way of another example, the vehicle controller 100 may monitor the cutting height of the mower deck 80 at each location to determine the vegetation height data. By way of another example, the vehicle controller 100 may monitor the elevation of the vehicle 10 at each location to determine the topographic data.

By way of another example, the vehicle controller 100 may monitor which locations the vehicle 10 enters while the mower deck 80 is active (e.g., turned on, cutting, etc.) to determine the boundaries of the fairway 404 and/or the permission data. In one such example, the vehicle 10 travels throughout a range of locations having an outer perimeter and an inner perimeter. The vehicle controller 100 may determine that the outer and inner perimeters represent the boundaries of the fairway 404 (e.g., areas cut by the vehicle 10 during the training period are considered part of the fairway 404, and areas that were not cut by the vehicle 10 during the training period are considered to be other zones). The vehicle controller 100 may determine that the inner perimeter defines a hazard, such as a bunker 410 or a pond, and update the permission data to prevent the vehicle 10 from traveling into the hazard in the future.

### Determining Current Conditions

Whereas step 302 of the method 300 is a setup process for preparing the vehicle 10 for normal operation in the operating area, steps 304, 306, 308, 310, 312, 314, and 316 represent the normal operation of the vehicle 10. Steps 304-316 may be performed repeatedly throughout normal operation, returning back to step 304 after step 316 is completed. While the method 300 is shown with a specific set of steps in a specific order, in other embodiments one or more steps are omitted and/or the order of the steps is modified.

In steps 304-310, various current conditions are determined. The vehicle controller 100 may determine the conditions based on data from the sensors 90, the user sensors 220, the user portal 230, the remote systems 240, and/or commands sent to components of the vehicle 10. The current conditions may represent current conditions of the vehicle 10 and/or current conditions of the surrounding environment.

In step 304, the position of the vehicle 10 is determined, and in step 306 the speed and heading of the vehicle 10 are determined. The position, the speed, and the heading of the vehicle 10 may represent location data for the vehicle 10. The position, speed, and heading of the vehicle 10 may be determined based on sensors 90 onboard the vehicle 10 and/or information from devices offboard the vehicle 10.

The position of the vehicle 10 (e.g., vehicle position data) may represent the two-dimensional position of the vehicle 10 (e.g., the position of the vehicle 10 in a horizontal plane, the latitude and longitude coordinates of the vehicle 10, etc.). The two-dimensional position of the vehicle 10 may be measured absolutely (e.g., relative to the Earth) or determined relative to a starting position (e.g., by integrating the change in position of the vehicle 10 over time). Additionally or alternatively, the position of the vehicle 10 may represent the elevation of the vehicle 10 (e.g., relative to sea level). The elevation may be measured directly or determined based on the two-dimensional position of the vehicle 10. By way of example, the elevation of the vehicle 10 may be determined by correlating the two-dimensional position of the vehicle 10 with a topographical map (e.g., the topographic data) of the operating area.

The speed of the vehicle 10 may represent the rate at which the vehicle 10 is moving and may be provided as vehicle speed data. The heading of the vehicle 10 may represent the direction in which the vehicle 10 is traveling and may be provided as vehicle heading data or vehicle direction data.

In some embodiments, the sensors 90 include sensors that measure the position of the vehicle 10. The sensors 90 may include a GPS receiver that receives GPS information and/or an RTK receiver that receives RTK information from the remote systems 240. In some embodiments, the GPS information is accurate to approximately 3 m. In some embodiments, the RTK information is accurate to approximately 1 cm. The GPS information and/or the RTK information may provide the two-dimensional position of the vehicle 10 (e.g., as latitude and longitude coordinates) and/or the elevation of the vehicle 10. In some embodiments, the sensors 90 include an altimeter or another sensor that measures the elevation of the vehicle 10.

In some embodiments, the position of the vehicle 10 is determined based on information received from other vehicles 10 and/or other devices. By way of example, each vehicle 10 of a fleet may be outfitted a communication interface 106 that communicates wirelessly with the communication interfaces 106 of the other vehicles 10 (e.g., through Bluetooth, radio, or another type of wireless communication). The communication interfaces 106 may form a mesh network, such that the vehicles 10 may communicate directly with one another or indirectly through other vehicles 10. The mesh network may include other devices, such as dedicated repeater beacons that facilitate transmission of data over longer distances or to other devices (e.g., through a different communication protocol). The signals transmitted between the communication interfaces 106 may provide an indication of the relative positions of the vehicles 10. By way of example, signal strength may have a predetermined relationship to the distance between two devices in communication with one another. Based on the collective information available regarding each of the communication signals, the vehicle controller 100 may determine the relative positions of the devices. By way of example, if a group of vehicles 10 are all in communication with one another, the vehicle controller 100 may be able to determine the relative positions of the vehicles 10 based on the strengths of each of the signals (e.g., by triangulation).

Information regarding the position of a vehicle 10 (e.g., GPS information, the RTK information, data from an altimeter, communication signals between a group of devices, etc.) may be used to determine the speed and heading of the vehicle 10. By way of example, the vehicle controller 100 may determine the speed and heading of the vehicle 10 by monitoring the change in the position of the vehicle 10 (e.g., calculating the derivative of the measured position).

In some embodiments, the sensors 90 include a compass, gyroscope, IMU or other device that measures the heading of the vehicle. In some embodiments, the sensors 90 include an accelerometer, IMU, odometer, or another device that provides information regarding the speed of the vehicle 10. The vehicle speed data and/or the vehicle heading data may be used to determine the position of the vehicle 10. By way of example, the vehicle controller 100 may determine the position of the vehicle 10 by using the heading and speed of the vehicle 10 to determine the change from a starting position of the vehicle 10 (e.g., by integrating the change in position over time).

In step 308 of the method 300, the status of the vehicle 10 is determined (e.g., vehicle status data is generated). The status of the vehicle 10 may be determined based on data from the sensors 90, based on commands being sent to various components of the vehicle 10, and/or based on information from outside sources.

In some embodiments, the status indicates an operating condition of one or more of the mower decks 80. The operating condition of a mower deck 80 may indicate whether the mower deck 80 is active (e.g., operating). If the mower deck 80 is active, the vehicle 10 may be considered to be performing a mowing operation. If the mower motor 86 is operating, or if a clutch has connected the cutting element 84 to the prime mover 52, the mower deck 80 may be considered active. If the mower motor 86 is powered off, or if a clutch has disconnected the cutting element 84 from the prime mover 52, the mower deck 80 may be considered active. By way of example, the vehicle controller 100 may monitor the current commands being sent to the mower motor 86 and/or the clutches to determine whether the mower deck 80 is active.

The operating condition of the mower deck 80 may indicate a rotational speed of the cutting element 84 of a mower deck 80. By way of example, a sensor 90 may monitor the rotational speed of the cutting element 84 and/or the mower motor 86, and the resultant measurement may be considered the current speed of the mower deck 80. In some embodiments, the speed of the mower deck 80 is used to determine if the mower deck 80 is active. By way of example, the mower deck 80 may be considered inactive until the speed exceeds a predetermined threshold.

The operating condition of the mower deck 80 may indicate a cutting height of the mower deck 80 (e.g., a vertical position of a housing 82 relative to the frame 12 of the vehicle 10). By way of example, a sensor 90 may monitor the cutting height of the mower deck 80 (e.g., by measuring a length of the corresponding deck actuator 88). In some embodiments, the cutting height of the mower deck 80 is used to determine if the mower deck 80 is active. By way of example, the mower deck 80 may be considered inactive until the cutting height of the mower deck 80 falls below a predetermined threshold (e.g., a travel height).

In some embodiments, the status indicates an operating condition of the driveline 50. By way of example, the operating condition of the driveline 50 may indicate a current drive speed and direction of the driveline 50 (e.g., driving forward, driving at 50% of the maximum speed, etc.). By way of another example, the operating condition of the driveline 50 may indicate a current steering operation of the driveline 50 (e.g., turning left, turning 15 degrees to the right, etc.). The operating conditions of the driveline 50 may be determined based on the commands provided to the driveline 50. The operating conditions of the driveline may be determined using one or more sensors 90.

In step 310 of the method 300, the condition of vegetation near the vehicle 10 is determined. Vegetation (e.g., grass, weeds, etc.) may change in consistency based on how wet the vegetation is (e.g., the moisture content of the vegetation, the amount of exterior moisture on the vegetation). The wetness of the vegetation is of interest, as wetter vegetation may require different operating conditions of the mower decks 80 to cut properly. The condition of the vegetation may be monitored by one or more sensors 90 or determined based on other data.

Vegetation may become more difficult to cut when wet. Accordingly, the wetness of the vegetation may be determined based on the power required to drive the cutting elements 84. In some embodiments, a sensor 90 measures the power consumed by a mower motor 86 (e.g., by measuring an electrical current supplied to the mower motor 86). As the wetness of the vegetation increases, the power consumed by the mower motor 86 may increase. Accordingly, a predetermined relationship between the wetness of the vegetation may be stored in the vehicle controller 100.

Vegetation wetness may be driven by weather conditions (e.g., precipitation, drought, etc.). In some embodiments, the remote systems 240 provide third party weather data (e.g., from a paid or government-based weather monitoring service). The weather data may indicate when precipitation occurred, how much precipitation was provided (e.g., in inches of rain), and/or a type of precipitation that occurred (e.g., rain, sleet, hail, snow, etc.). A predetermined relationship between the type, amount, and timing of the precipitation and the wetness of the vegetation may be predetermined and stored in the vehicle controller 100.

In step 312 of the method 300, the vehicle controller 100 determines a desired operating state of the vehicle 10. The desired operating state may include a desired path for the vehicle 10 and/or desired operating conditions for the vehicle 10. In step 314, the path of the vehicle 10 is controlled based on the desired operating state. In step 316, the operation of the mower deck 80 is controlled based on the desired operating state of the vehicle 10. Steps 312-316 facilitate precision mowing and adaptive mowing, as described herein. After step 316 is concluded, the method 300 may return to step 304 and repeat.

### Precision Mowing

When performing precision mowing, the path of the vehicle 10 is controlled to achieve a desired mowing pattern. The mowing pattern followed by a mower can be visually identified for days or weeks after mowing, and thus has a significant impact on the aesthetics of a golf course or other outdoor area. In order to maximize the aesthetics of the golf course, it is desirable to consistently and precisely reproduce the desired mowing pattern. In other systems, the path of a mower is only controlled manually. This is a labor-intensive process, and skilled operators are required to produce the desired mowing pattern without deviations. Inconsistencies in mowing patterns due to manual operation may cause the boundaries of certain areas to drift over time. The vehicle 10 incorporates autonomy into the steering of the vehicle 10 to consistently produce a desired mowing pattern, even without the need for a skilled operator.

In step 312, a desired path for the vehicle 10 is identified as part of the desired operating state of the vehicle 10. In some embodiments, the desired path includes a series of desired positions for the vehicle 10 to follow. By way of example, the desired path may specify that the vehicle 10 should pass through coordinate X1, Y1, then coordinate X2, Y2, then coordinate X3, Y3, etc. In some embodiments, the desired path specifies a heading or direction of travel for the vehicle 10. By way of example, the desired path may specify that the vehicle 10 should face due north while traveling along the desired path.

In some embodiments, the desired path is based on the map data generated in step 310. Specifically, the desired path may utilize the mowing pattern data that is manually generated or the mowing pattern data that is recorded during a previous mowing operation in step 310. In some embodiments, different zones of a map are associated with different mowing pattern data. To determine which mowing pattern data applies, the location data may be used to determine the current position of the vehicle 10, and current position of the vehicle may be compared the geofences of the map.

The desired path for the vehicle 10 may be selected to replicate the mowing pattern in the map data as closely as possible. By way of example if the map of FIG. 6 were selected as the desired mowing pattern, the desired path may be selected to attempt to replicate the position, shape, and/or direction of the mower paths 460. In some embodiments, the location data may be used to determine the current position of the vehicle 10, and the desired path may be selected as the mower path 460 that is closest to the current position.

In other embodiments, the desired path is selected based on an input from an operator during a mowing operation (e.g., without using mowing pattern data from the map data). By way of example, an operator may orient the vehicle 10 in a desired direction and indicate (e.g., through the operator interface 48) that the desired path of the vehicle 10 and future paths of the vehicle 10 should extend parallel to the current heading of the vehicle 10. By way of another example, an operator may control the vehicle 10 to complete a mowing operation while recording the path taken by the vehicle 10, and the vehicle controller 100 may select the desired path as extending along (e.g., parallel to) and offset from the recorded path.

In some embodiments, after completing a mowing operation along a desired path, the vehicle controller 100 then generates a subsequent desired path for the vehicle 10. The desired paths may be offset a distance from one another. The vehicle controller 100 may select the distance such that adjacent mower paths overlap one another, preventing the occurrence of areas between adjacent mower paths that are not mowed. This distance may be predetermined based on the dimensions of the vehicle 10.

In step 314, the vehicle controller 100 controls the vehicle 10 to follow the desired path. In some embodiments, the vehicle controller 100 initiates step 314 in response to predetermined conditions. In some embodiments, the vehicle controller 100 only initiates step 314 in response to a determination that one or more of the mower decks 80 are active. The vehicle controller 100 may terminate the automated control of step 314 in response to a determination that one or more of the mower decks 80 are inactive.

In some embodiments, the vehicle controller 100 initiates and/or terminates step 314 based on a predefined geofence. Referring to the example map section 450 shown in FIG. 6, the vehicle controller 100 may initiate step 314 in response to a determination that the vehicle 10 has crossed the geofence between the border region 456 and the pattern region 458 and entered the pattern region 458. By way of example, the vehicle controller 100 may terminate step 314 in response to a determination that the vehicle 10 has crossed the geofence between the border region 456 and the pattern region 458 and entered the border region 456. Referring to the map 400 shown in FIG. 5, the vehicle controller 100 may initiate step 314 in response to a determination that the vehicle 10 has crossed the geofence between the cart path 420 and the rough 402 and entered the rough 402. The vehicle controller 100 may terminate step 314 in response to a determination that the vehicle 10 has crossed the geofence between the cart path 420 and the rough 402 and entered the cart path 420.

When performing step 314, the vehicle controller 100 may utilize location data indicating a current path of the vehicle 10 (e.g., as determined in steps 304 and 306). The vehicle controller 100 may compare the current path of the vehicle 10 with the desired path of the vehicle 10 and determine if the current path deviates from the desired path. If the current path of the vehicle 10 follows the desired path, the vehicle controller 100 may continue without adjustment. If the current path is determined to deviate from the desired path, the vehicle controller 100 may act to oppose the deviation (e.g., by reducing the deviation or preventing further deviation).

To oppose the deviation, the vehicle controller 100 may control the driveline 50, directly or indirectly, to steer the vehicle 10. In some embodiments, the vehicle controller 100 controls the driveline 50 directly. By way of example, the vehicle controller 100 may control the steering actuator 59 to steer the vehicle 10 as desired. By way of another example, the vehicle controller 100 may vary the relative speeds of the left and right sides of the driveline 50 to steer the vehicle 10. In some embodiments, the vehicle controller 100 indirectly controls the driveline 50. By way of example, the vehicle controller 100 may operate the haptic actuator 49 to control a position of the steering wheel 42, which in turn steers the driveline 50. The vehicle controller 100 may determine a position of the steering wheel 42 that will bring the vehicle 10 toward the desired path and control the haptic actuator 49 to move the steering wheel 42 to that position.

In embodiments where the vehicle controller 100 steers the driveline 50, the vehicle controller 100 may permit a manual override of the steering. By way of example, the sensors 90 may include a sensor (e.g., a torque sensor, a force sensor, etc.) that detects a force exerted by the operator on the steering wheel 42. The vehicle controller 100 may monitor the force exerted by the operator on the steering wheel 42 using the sensor 90. In response to a determination that the force has exceeded a predetermined threshold force, the vehicle controller 100 may stop automatically steering the driveline 50, terminate the step 314, and permit the operator to manually steer the vehicle 10. This manual override may be useful when encountering unexpected obstacles that the operator steers around to avoid.

In some embodiments, while the vehicle controller 100 operates the steering of the driveline 50, the operator manually controls the travel speed of the vehicle 10. By way of example, the traction pedal 44 may be usable independent of the automated steering to control the travel speed. In one such example, the operator releases the steering wheel 42 to permit automated steering while using their foot to control the traction pedal 44 and set the desired travel speed.

In other embodiments, the vehicle controller 100 automatically controls both the steering and the travel speed of the vehicle 10, such that the vehicle 10 operates autonomously in step 314. In such embodiments, the vehicle controller 100 may have complete control over the movement of the vehicle 10. The vehicle controller 100 may perform the autonomous operation to mow the entirety of an operating area, or the vehicle controller 100 may perform the autonomous operation only in certain zones or areas (e.g., only when moving in straight lines). An operator may be present onboard the vehicle 10 during the operation (e.g., to monitor the progress of the mowing operation and intervene if necessary). An operator may take the vehicle 10 out of the autonomous operation and initiate manual control by interacting with the operator controls 40.

In some embodiments, the operator manually steers the driveline 50 (e.g., through the steering wheel 42), and the vehicle controller 100 opposes the deviation of the current path from the desired path by providing haptic feedback to the operator indicating how the vehicle 10 should be steered. By way of example, the haptic actuator 49 may vibrate the steering wheel 42 to indicate when the operator should update the steering direction. By way of another example, the haptic actuator 49 may apply a force that opposes movement of the steering wheel 42 away from the desired path and/or a force that encourages movement of the steering wheel 42 toward the desired path.

### Zone Access Permissions

In some embodiments, the map data includes permission data that indicates whether or not a vehicle 10 is permitted to enter a particular zone. The vehicle controller 100 may analyze the current path of the vehicle 10 in view of the permission data. If the current path of the vehicle 10 passes into a zone that the vehicle 10 is permitted to enter, the vehicle controller 100 may take no action and permit the vehicle 10 to enter the zone.

If the current path of the vehicle 10 passes into a zone that the vehicle 10 is not permitted to enter (e.g., is forbidden from entering), the vehicle controller 100 may update the desired path to avoid the zone. The vehicle controller 100 may control the steering and/or the speed of the driveline 50 to avoid entering the zone. By way of example, the vehicle controller 100 may automatically steer away from the zone. By way of another example, the vehicle controller 100 may limit the speed of the vehicle 10 (e.g., to a low speed, to a stopped condition) when the vehicle 10 is traveling toward or within the zone. If the vehicle 10 is within a zone that the vehicle 10 is not permitted to enter, the vehicle controller 100 may update the desired path to attempt to exit the zone. By way of example, the vehicle controller 100 may automatically steer away from the zone and toward another zone that the vehicle 10 is permitted to enter.

Different vehicles or different types of vehicles may have different zone permissions. In some embodiments, the zone permissions are based on the type of surface within the zone (e.g., the surface type data and/or vegetation type data). By way of example, a vehicle 10 configured as a mower may be permitted to access zones with grass and pavement, but may be prevented from entering bunkers or fescue. By way of another example, a vehicle 10 configured as a golf car may be permitted to access zones with pavement (e.g., the cart paths 420 and the parking lot 422). Some zones, such as the building 424, may be off limits to all vehicles 10.

In some embodiments, the permission data may be dynamic based on certain factors. By way of example, the permission data may be modified by an operator (e.g., a system administrator) through the user portal 230. In one such example, the administrator designates whether or not a “cart path only” rule is in effect (e.g., based on current weather conditions). When the rule is in effect, golf cars may be limited to only zones having paved surfaces. When the rule is not in effect, golf cars may be permitted to enter both zones having paved surfaces and zones containing grass. By way of another example, the permission data may vary over time (e.g., based on a date, day of the week, or time of day). In one such example, vehicles 10 configured as mowers are prevented from entering the greens during operating hours of a golf course. In another such example, the “cart path only” rule is in effect on specific days of the week.

### Adaptive Mowing

When performing adaptive mowing, the operating conditions of the mower decks 80 are automatically controlled to achieve a desired property of the area mowed by the vehicle 10. Different areas of a golf course or other operating area may have different desired properties. For example, different areas may require different cutting heights (e.g., as defined in the vegetation height data). In other systems, these operating conditions are controlled manually. This is a labor-intensive process, and the need to manually change the operating conditions may limit how often the operating conditions can practically be changed. Additionally, different operators may not be consistent in their manual control over the operating conditions. This can lead to inconsistencies in the mowed surface and potentially cause damage to the grass (e.g., if a cutting height of the mower deck 80 is set lower than intended). The vehicle 10 incorporates autonomy into adjusting the operating conditions of the mower decks 80, permitting the operating conditions to be updated frequently, consistently, and without manual intervention by an operator.

In step 312, the vehicle controller 100 identifies one or more desired operating conditions for one or more of the mower decks 80 as part of the desired operating state of the vehicle 10. In step 316, the vehicle controller 100 controls operation of the mower deck 80 based on the desired operating state. Step 316 may be performed with or without feedback from a sensor 90. Accordingly, the adaptive mowing functionality permits the vehicle controller 100 to automatically identify and achieve a desired operating condition for the mower deck 80 (e.g., without intervention by an operator).

In some embodiments, the desired operating state includes a desired cutting speed of a mower deck 80. The vehicle controller 100 may receive a measurement of the cutting speed (e.g., a rotational speed of the cutting element 84) from a sensor 90 (e.g., a rotational speed sensor). The vehicle controller 100 may control the mower motor 86 to drive the cutting element 84 at the desired speed. By way of example, the vehicle controller 100 may change the cutting speed from a first nonzero speed to a second nonzero speed. In some embodiments, the vehicle controller 100 sets the cutting speed to zero (e.g., stops the cutting element 84). The vehicle controller 100 may stop the cutting element 84 by turning off the mower motor 86 and/or disengaging a clutch coupled to the cutting element 84.

In some embodiments, the desired operating state includes a desired cutting height of a mower deck 80. The vehicle controller 100 may receive a measurement of the cutting height (e.g., a vertical position of the mower deck 80) from a sensor 90 (e.g., a linear potentiometer). The vehicle controller 100 may control a deck actuator 88 to move the corresponding mower deck 80 to the desired cutting height.

In some embodiments, the vehicle controller 100 determines the desired operating conditions for a mower deck 80 based on a location of the vehicle 10 (e.g., provided in the location data). By way of example, the vehicle controller 100 may utilize the map data generated in step 310. In some embodiments, different zones of a map are associated with different predetermined desired operating conditions (e.g., vegetation height data, surface type data, etc.). To determine which desired operating conditions apply, the location data may be used to determine the current position of the vehicle 10, and current position of the vehicle may be compared with the geofences of the map.

One example is described with respect to the map 400 of FIG. 5. The location data may initially indicate that the vehicle 10 is positioned within the boundaries of the cart path 420. The map data for the cart path 420 may indicate that the surface of the cart path 420 is paved. Accordingly, the desired operating conditions for the mower deck 80 may indicate that the mower deck 80 should be turned off (e.g., rotation of the cutting element 84 should be stopped) and the mower deck 80 should be raised to a travel height. In response to this determination, the vehicle controller 100 may automatically control the mower motor 86 to stop the cutting element 84 and control the deck actuator 88 to move the mower deck 80 to the travel height.

The location data may subsequently indicate that the vehicle 10 has passed through the geofence surrounding the cart path 420 and entered the rough 402. The map data for the rough 402 may indicate that the rough includes a first type of grass, and the grass should have a first vegetation height. The desired operating conditions for the mower deck 80 may indicate that the cutting speed should be set to a first speed corresponding to the first type of grass, and the cutting height should be set to a first cutting height corresponding to the first vegetation height. In response to this determination, the vehicle controller 100 may automatically control the mower motor 86 to drive the cutting element 84 at the first speed and control the deck actuator 88 to move the mower deck 80 to the first cutting height.

The location data may subsequently indicate that the vehicle 10 has passed through the geofence along the rough 402 and entered the fairway 404. The map data for the fairway 404 may indicate that the fairway includes a second type of grass, and the grass should have a second vegetation height lower than the first vegetation height. The desired operating conditions for the mower deck 80 may indicate that the cutting speed should be set to a second speed corresponding to the second type of grass, and the cutting height should be set to a second cutting height corresponding to the second vegetation height. In response to this determination, the vehicle controller 100 may automatically control the mower motor 86 to drive the cutting element 84 at the second speed and control the deck actuator 88 lower the mower deck 80 to the second cutting height.

In some embodiments, the vehicle controller 100 determines the desired operating conditions for a mower deck 80 based on a travel speed of the vehicle 10. The travel speed may be provided as part of the location data. In some embodiments, a relationship between desired cutting speed and travel speed is predetermined and stored by the vehicle controller 100. By way of example, the desired cutting speed may increase as the travel speed increases, and the desired cutting speed may decrease as the travel speed decreases. This relationship may prevent the mower deck 80 from getting bogged down and facilitate a clean cut, at least because the cutting element 84 moves more quickly as vegetation is introduced more to the cutting element 84. The vehicle controller 100 may control the mower motor 86 to maintain the cutting speed at the desired cutting speed.

In some embodiments, the vehicle controller 100 determines the desired operating conditions based on an elevation of the vehicle 10 (e.g., a change in elevation, whether the vehicle 10 is moving downhill or uphill, etc.). The elevation may be provided as part of the location data. In some embodiments, the vehicle controller 100 monitors the change in elevation over time to determine if the vehicle is moving uphill or downhill and/or the grade (e.g., slope, angle of incline, etc.) of the hill. In some embodiments, the vehicle controller 100 receives data from a gyroscope indicating an orientation of the frame 12. Based on the orientation of the chassis, the vehicle controller 100 may determine if the vehicle 10 is moving uphill or downhill and/or the grade of the hill. In some embodiments, the vehicle controller 100 determines the desired cutting speed based on whether the vehicle 10 is moving uphill or downhill. By way of example the vehicle controller 100 may increase the desired cutting speed moving downhill and decrease the cutting speed when moving uphill. The vehicle controller 100 may control the mower motor 86 to maintain the cutting speed at the desired cutting speed.

In some embodiments, the vehicle controller 100 determines the desired operating conditions based on the conditions of vegetation in the surrounding environment, such as vegetation wetness. The conditions of the vegetation, such as vegetation wetness, may be determined based on weather data, power consumption of the mower motor 84, or other data. The vehicle controller 100 may store a predetermined relationship between (a) vegetation conditions and (b) desired cutting speed and/or desired cutting height. By way of example, in response to an increase in vegetation wetness, the vehicle controller 100 may increase the desired cutting speed and increase the desired cutting height.

As utilized herein with respect to numerical ranges, the terms “approximately,” “about,” “substantially,” and similar terms generally mean+/−10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the figures. It should be noted that the orientation of various elements may differ according to other exemplary embodiments, and that such variations are intended to be encompassed by the present disclosure.

The hardware and data processing components used to implement the various processes, operations, illustrative logics, logical blocks, modules, and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the vehicle 10 and the systems and components thereof (e.g., the body 20, the operator controls 40, the driveline 50, the suspension system 60, the braking system 70, the vehicle controller 100, etc.) as shown in the various exemplary embodiments is illustrative only. Additionally, any element disclosed in one embodiment may be incorporated or utilized with any other embodiment disclosed herein. By way of example, a vehicle controller 100 may utilize both precision mowing and adaptive mowing.

1. A mower, comprising:
a chassis;
a tractive element coupled to the chassis;
a cutting unit coupled to the chassis, the cutting unit including a housing and a cutting element rotatably coupled to the housing;
a motor configured to move the cutting element relative to the housing; and
a controller operatively coupled to the motor and configured to:
receive location data indicating at least one of a position or a travel speed of the mower; and
vary an operating condition of the cutting unit based on the location data.

2. The mower of claim 1, wherein the operating condition is a speed of the cutting element, and wherein the controller is configured to vary the speed of the cutting element based on the location data.

3. The mower of claim 2, wherein the controller is configured to stop rotation of the cutting element relative to the housing based on the location data.

4. The mower of claim 2, wherein the controller is configured to control the motor to change the speed of the cutting element from a first speed to a second speed based on the location data, and wherein the first speed and the second speed are not stationary relative to the housing.

5. The mower of claim 1, further comprising a deck actuator operatively coupled to the controller and configured to raise the housing relative to the chassis, wherein the controller is configured to control the deck actuator to adjust a cutting height of the cutting unit based on the location data.

6. The mower of claim 1, wherein the location data indicates the position of the mower, and wherein the controller is configured to vary the operating condition of the cutting unit in response to a determination that the mower has passed through a predefined geofence based on the location data.

7. The mower of claim 6, wherein the controller is configured to stop rotation of the cutting element relative to the housing in response to the determination that the mower has passed through the predefined geofence.

8. The mower of claim 6, further comprising a deck actuator operatively coupled to the controller and configured to raise the housing relative to the chassis, wherein the controller is configured to control the deck actuator to adjust a cutting height of the cutting unit in response to the determination that the mower has passed through the predefined geofence.

9. The mower of claim 1, wherein the location data indicates the travel speed of the mower, and wherein the controller is configured to vary the operating condition of the cutting unit based on the travel speed of the mower.

10. The mower of claim 9, wherein the controller is configured to control the motor to increase a rotational speed of the cutting element from a first speed to a second speed in response to an increase in the travel speed of the mower, and wherein the first speed and the second speed are not stationary relative to the housing.

11. The mower of claim 1, wherein the location data indicates an elevation of the mower, and wherein the controller is configured to vary the operating condition of the cutting unit in response to a determination that the elevation of the mower is changing.

12. The mower of claim 11, wherein the controller is configured to control the motor to change a rotational speed of the cutting element from a first speed to a second speed in response to a determination that the elevation of the mower is increasing, and wherein the first speed and the second speed are not stationary relative to the housing.

13. The mower of claim 1, further comprising a sensor configured to provide power consumption data indicating an amount of power being consumed by the motor, wherein the controller is configured to control the motor to change a rotational speed of the cutting element from a first speed to a second speed based on the power consumption data, and wherein the first speed and the second speed are not stationary relative to the housing.

14. The mower of claim 1, wherein the controller is configured to receive weather data indicating that precipitation has occurred within an operating area associated with the mower, wherein the controller is configured to control the motor to change a rotational speed of the cutting element from a first speed to a second speed based on the weather data, and wherein the first speed and the second speed are not stationary relative to the housing.

15. A method of operating a mower, the method comprising:
receiving, from a sensor, location data indicating at least one of a position or a travel speed of the mower;
determining, based on the location data, at least one of a desired cutting speed for a cutting unit of the mower or a desired cutting height for the cutting unit of the mower; and
at least one of:
controlling a motor of the mower to adjust a cutting speed of the cutting unit to the desired cutting speed; or
controlling a deck actuator of the mower to adjust a cutting height of the cutting unit to the desired cutting height.

16. The method of claim 15, further comprising:
receiving map data defining desired operating states of the mower at predetermined locations within an operating area; and
determining the at least one of the desired cutting speed and the desired cutting height based on a comparison of the location data with the map data.

17. The method of claim 16, further comprising generating the map data by recording an operating state of the mower while the mower performs a mowing operation within the operating area.

18. The method of claim 17, wherein the location data is second location data indicating the position of the mower at a second time, further comprising:
receiving first location data indicating at least one of the position of the mower at a first time;
receiving cutting speed data from a first sensor indicating the cutting speed of the cutting unit at the first time;
receiving cutting height data from a second sensor indicating the cutting height of the cutting unit at the first time; and
generating the map data based on the first location data, the cutting speed data, and the cutting height data.

19. The method of claim 15, the method comprising both (a) controlling the motor to adjust the cutting speed of the cutting unit to the desired cutting speed and (b) controlling the deck actuator to adjust the cutting height of the cutting unit to the desired cutting height.

20. A vehicle system, comprising:
one or more processing circuits including one or more memory devices storing instructions thereon that, when executed by one or more processors, cause the one or more processors to:
receive, from at least one sensor, location data indicating a position and a travel speed of a mower;
control a motor of the mower to increase a cutting speed of a cutting unit of the mower in response to an increase in the travel speed of the motor; and
stop operation of the cutting unit in response to a determination that the mower has passed through a predefined geofence.
